(19) United States
(12) Patent Application Publication
(10) Pub. No.: US 2024/0069544 A1
(43) Pub. Date: Feb. 29, 2024

(54) CONTROL OF MULTIAGENT NETWORKS WITH MISBEHAVING VEHICLES OVER DIRECTED NETWORK TOPOLOGIES

(71) Applicant: UNIVERSITY OF SOUTH FLORIDA, Tampa, FL (US)

(72) Inventors: Emre Yildirim, Tampa, FL (US); Tansel Yucelen, Tampa, FL (US)

(21) Appl. No.: 18/456,444

(22) Filed: Aug. 25, 2023

Related U.S. Application Data
(60) Provisional application No. 63/401,045, filed on Aug. 25, 2022.

(51) Int. Cl. G05D 1/00

(52) U.S. Cl. CPC G05D 1/0027; G05D 1/0022

(57) ABSTRACT

Methods and systems for control of multiagent networks with misbehaving vehicles over directed network topologies are disclosed. The methods and systems include: identifying a plurality of possible misbehaving vehicles among a plurality of vehicles in the networked multiagent system, determining a directed sub-network of a subset of the plurality of vehicles based on a first directed communication path of a first possible misbehaving vehicle of the plurality of possible misbehaving vehicles to a first vehicle and a second directed communication path of a driver vehicle of the plurality of vehicles to the first vehicle; and implementing a proportional-integral controller for suppressing an effect of the misbehaving vehicle on the networked multiagent system. Other aspects, embodiments, and features are also claimed and described.

### CROSS-REFERENCE TO RELATED APPLICATION(S)

This application claims the benefit of U.S. Provisional Patent Application Ser. No. 63/401,045, filed Aug. 25, 2022, the disclosure of which is hereby incorporated by reference in its entirety, including all figures, tables, and drawings

### STATEMENT REGARDING FEDERALLY SPONSORED RESEARCH

This invention was made with government support under Grant Number CMMI-1657637 granted by National Science Foundation. The government has certain rights in the invention.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the present disclosure, methods, systems, and apparatus for networked multiagent system control are disclosed. These methods, systems, and apparatus can include steps or components for identifying a plurality of possible misbehaving vehicles among a plurality of vehicles in the networked multiagent system, determining a directed sub-network of a subset of the plurality of vehicles based on a first directed communication path of a first possible misbehaving vehicle of the plurality of possible misbehaving vehicles to a first vehicle and a second directed communication path of a driver vehicle of the plurality of vehicles to the first vehicle; and implementing a proportional-integral controller for suppressing an effect of the misbehaving vehicle on the networked multiagent system.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is a block diagram conceptually illustrating a multiagent system according to some embodiments.

FIG. 2 is a flowchart illustrating an example process for multiagent system control according to some embodiments.

FIG. 3 is an example multiagent system according to some embodiments.

FIG. 4 is another example multiagent system according to some embodiments.

FIG. 5 is another example multiagent system according to some embodiments.

FIG. 6 is a graph showing a response of vehicles in a directed subgraph where there are no additional driver vehicles in a directed network or graph.

FIG. 7 is a graph showing a response of nodes in a directed subnetwork or subgraph where there are additional driver vehicles in a directed network or graph.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

The control of multiagent networks with misbehaving vehicles or nodes in an active research area. Prior research generally requires applying feedback control signals to every vehicle or node for suppressing the effect of misbehaving vehicles or nodes on the overall multiagent network. However, this requirement can be impractical for multiagent networks having a large number of nodes due to economical reasons and multiagent networks having a certain number of inaccessible nodes due to the fact that feedback control signals cannot be physically applied to such nodes. Proposed herein are proportional-integral feedback controllers which stabilize the overall multiagent network in the sense of input-to-state stability. Further, a graph=theoretical approach is used to allow users to find stead-state values of critical nodes without requiring the knowledge of the Laplacian matrix of the overall multiagent network. The results presented in this paper pave the way in understanding how the driver nodes need to be selected for suppressing the effect of misbehaving nodes on the neighborhood of the critical nodes.

The contribution set forth is to study multiagent networks over directed graph topologies with a number of nodes subject to exogenous disturbances (i.e., misbehaving nodes0, where the number of nodes that feedback control signals are applied (i.e., driver nodes) can be less than the total number of nodes in the overall multiagent network. To this end, proportional-integral feedback controllers are proposed for driver nodes. It is shown that these controllers make the resulting closed-loop system matrix Hurwitz, and therefore, stabilize the overall multiagent network in the sense of input-to state stability. In addition, a graph-theoretical approach is used to determine steady-state values of critical nodes without requiring the knowledge of the Laplacian matrix of the overall multiagent network. The results presented in this paper pave the way in understanding how the driver nodes need to be selected for suppressing the effect of misbehaving nodes on the neighborhood of the critical nodes, which is further illustrated herein.

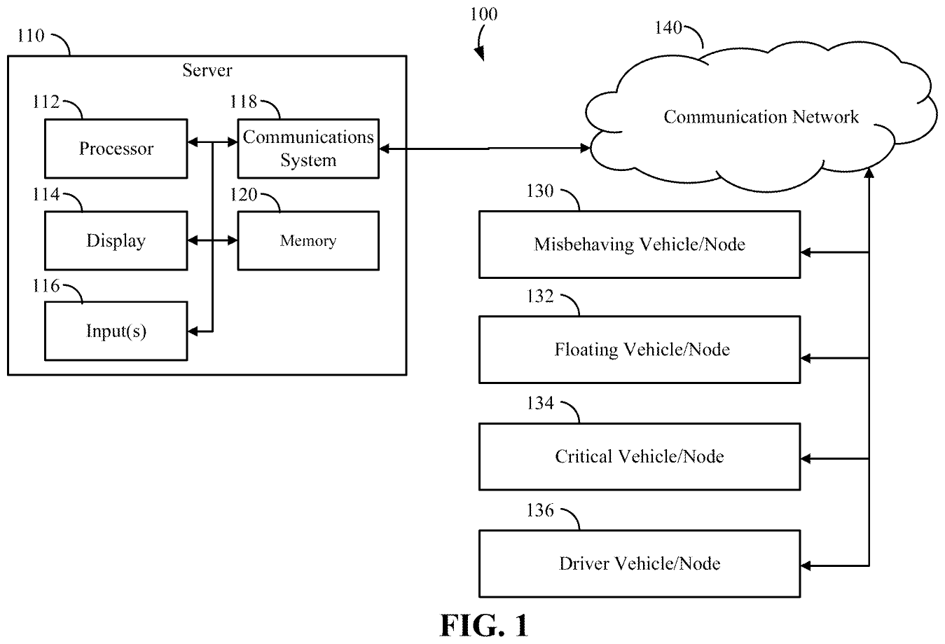

FIG. 1 is a block diagram conceptually illustrating a multiagent system. For example, the multiagent system 100 can include various types of vehicles or nodes. For example, the multiagent system 100 can include a misbehaving vehicle or node 130, a floating vehicle or node 132, a critical vehicle or node 134, and/or a driver vehicle or node 136. In the multiagent system 100, each of the driver node or node 136, the misbehaving vehicle or node 130, the floating vehicle or node 132, and/or the critical vehicle or node 134 can be communicatively connected to one or more neighboring vehicles or nodes via a communication network 140. In some examples, the system 100 can include a server 110 for determining possible misbehaving vehicles or nodes, determining or designing a directed network or a directed graph of the vehicles or nodes 130, 132, 134, 136, 138, and/or implementing a proportional-integral controller in the networked multiagent system.

In some examples, each vehicle or node 130, 132, 134, 136 can communicate each other, and communicate from or to a server 110 (e.g., before performing a task) over a communication network 140. In some examples, the communication network 140 can be any suitable communication network or combination of communication networks. For example, the communication network 140 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 140 can be a local area network, a wide area network, a public network (e.g., the Internet), a private or semi-private network (e.g., a corporate or university intranet), any other suitable type of network, or any suitable combination of networks. Communications links between vehicles or nodes 130, 132, 134, 136 and/or the server 110 can be any suitable communications link or combination of communications links, such as wired links, fiber optic links, Wi-Fi links, Bluetooth links, cellular links, etc.

In further examples, the vehicle or node 110, 130, 132, 134 can be a node (e.g., a ground node, an aerial node, an underwater node, a ship, a space node, an autonomous node, a motor node, a space node, car, a train, an unmanned aerial node, a rocket, or a missile, etc.) or any other suitable apparatus or means (e.g., a computing/circuit/electrical node). The vehicle or node 110, 130, 132, 134 can include any suitable computing device or combination of devices, such as a processor (including an ASIC, DSP, PFGA, or other processing component) desktop computer, a laptop computer, a smartphone, a tablet computer, a wearable computer, a server computer, a computing device integrated into the node, a camera, a robot, a virtual machine being executed by a physical computing device, etc. In some examples, the driver vehicle or node 136 can receive feedback control signals, the misbehaving vehicle or node 130 is subject to exogenous disturbances, the floating vehicle or node 132 is subject to neither exogenous disturbances nor feedback control signals, and the critical vehicle or node 134 is a node that can affect the structure and function of the multiagent system to a greater extent. In some example, the critical vehicle or node 134 can be a node where a given tasks may not be accomplished without the node. For example, consider that the multiagent system can have a group of unmanned aerial nodes, and they are performing a task. The main purpose of these aerial nodes to attack certain locations. Non-critical nodes are utilized for distracting enemy defensive system but only the critical nodes have sufficient equipment to perform the task such as bombing a location.

In some examples, the server 110 can include a processor 112, a display 114, one or more inputs 116, one or more communication systems 118, and/or memory 120. In some embodiments, the processor 112 can be any suitable hardware processor or combination of processors, such as a central processing unit (CPU), a graphics processing unit (GPU), an application specific integrated circuit (ASIC), a field-programmable gate array (FPGA), a digital signal processor (DSP), a microcontroller (MCU), etc. In some embodiments, the display 114 can include any suitable display devices, such as a computer monitor, a touchscreen, a television, an infotainment screen, etc. In some embodiments, the input(s) 116 can include any suitable input devices and/or sensors that can be used to receive user input, such as a keyboard, a mouse, a touchscreen, a microphone, etc.

In further examples, the communications system 118 can include any suitable hardware, firmware, and/or software for communicating information over communication network 140 and/or any other suitable communication networks. For example, the communications system 118 can include one or more transceivers, one or more communication chips and/or chip sets, etc. In a more particular example, the communications system 118 can include hardware, firmware and/or software that can be used to establish a Wi-Fi connection, a Bluetooth connection, a cellular connection, an Ethernet connection, etc. to communicate with other node, server, or any other suitable computing device.

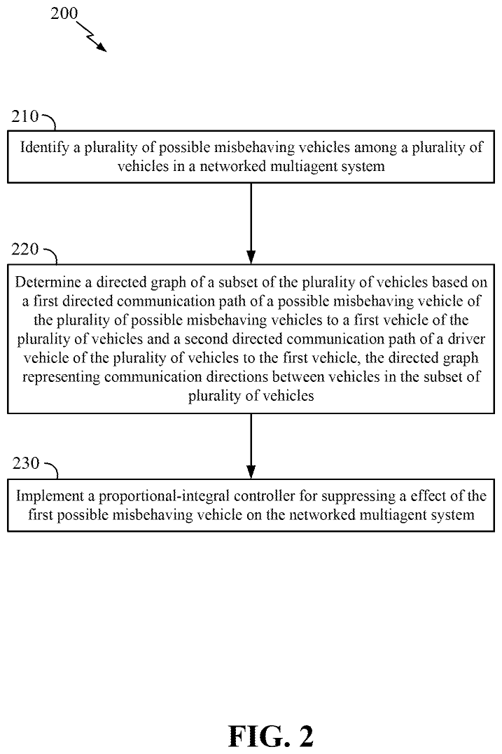

In further examples, the memory 120 can include any suitable storage device or devices that can be used to store a directed graph of the multiagent system 100, a proportional-integral controlling algorithm, data, instructions, values, etc., that can be used, for example, by the processor 112 to perform information exchange tasks via communications system 118, etc. The memory 120 can include any suitable volatile memory, non-volatile memory, storage, or any suitable combination thereof. For example, memory 120 can include random access memory (RAM), read-only memory (ROM), electronically-erasable programmable read-only memory (EEPROM), one or more flash drives, one or more hard disks, one or more solid state drives, one or more optical drives, etc. In some embodiments, the memory 120 can have encoded thereon a computer program for controlling operation of computing device 110. For example, in such embodiments, the processor 112 can execute at least a portion of the computer program to perform one or more data processing tasks described herein, transmit/receive information via the communications system 118, etc. As another example, processor 112 can execute at least a portion of process 200 described below in connection with FIG. 2.

In some examples, the multiagent system can include the misbehaving node 130, the floating node, 132, the critical node 134, and/or the driving node 136. The misbehaving node 130, the floating node, 132, the critical node 134, and/or the driving node 136 can include system components (e.g., a processor, a display, an input, a communications system, and/or memory) similar to those in the server 110. In other examples, each node 130, 132, 134, 136 may have a fewer system components than the server 110 (e.g., as an embedded or sensor device). further examples, a type of node can become a different type at any suitable time. For example, a driver node 110 in the multiagent system 100 can be a misbehaving node 130, a floating node 132, or a critical node 134 at any suitable time, or vice versa.

FIG. 2 is a flowchart illustrating an example process for information exchange. In some examples, the process 200 for information exchange in a multiagent system may be carried out by the server 110, the misbehaving node 130, the floating node, the critical node 134, the driving node 136, and/or any other suitable computing device illustrated in FIG. 1. In some examples, the server 110 may perform the process 200 (e.g., using an input or a human intervention/interaction). Additionally, although the steps of the flowchart 200 are presented in a sequential manner, in some examples, one or more of the steps may be performed in a different order than presented, in parallel with another step, or bypassed.

Before describing the process 200, the notation and some basic definitions used throughout the process 200 are explained. [symbol] and [symbol] _{>0} respectively denote the sets of real numbers and positive real numbers; [symbol] and [symbol] respectively denote the sets of n×1 real column vectors and n×m real matrices; 1ₙ denotes the n×1 vector of all ones; diag(a₁, . . . , aₙ) denotes a diagonal matrix with scalar entries a₁, . . . , aₙ on its diagonal; (⋅)⁻¹ and (⋅)^{T} respectively denote the inverse of a (nonsingular) matrix and the transpose of a matrix; and “ [symbol] ” denotes the equality by definition.

Additionally, [symbol] =(V( [symbol] ), ε( [symbol] )) is used to denote a fixed, connected, and directed graph with [symbol] ( [symbol] )={v₁, . . . , vₚ} being a nonempty finite set of n nodes and ε( [symbol] )⊂ [symbol] ( [symbol] )× [symbol] ( [symbol] ) being a set of edges. There is an edge rooted at node vⱼ and ended at node vᵢ (i.e., (vⱼ, vᵢ)∈ε( [symbol] )) if and only if vᵢ receives information from vⱼ. Furthermore, [symbol] =[aᵢⱼ]∈ [symbol] denotes the adjacency matrix of the graph [symbol] , where aᵢⱼ=1 if (vⱼ, vᵢ)∈ε( [symbol] ) and aᵢⱼ=0 otherwise (self-loops are not allowed; that is, aᵢᵢ=0, i=1, . . . , n). In-degree and Laplacian matrices of the graph [symbol] are respectively defined as [symbol] =diag(d₁, . . . , dₙ) with dᵢ=Σᵢ₋ⱼaᵢⱼ for all vᵢ∈ [symbol] ( [symbol] ) and [symbol] = [symbol] − [symbol] ( [symbol] has zero row sums; that is, [symbol] 1ₙ=0). Finally, a directed path from node vᵢ to node vⱼ is a sequence of successive edges in the form (vᵢ, vₚ), (vₚ, v_{q}), . . . , (vᵣ, vⱼ) (a directed path can consist of a single node), where a directed graph [symbol] has a spanning tree in the union of the root nodes has a directed path to every other node in the graph [symbol] .

At step 210, the process 200 for multiagent system control can identify or determine multiple possible misbehaving vehicles or nodes among multiple vehicles or nodes in a networked multiagent system. In some examples, the process 200 can identify or determine the possible misbehaving vehicles or nodes based on a predetermined susceptible region. In some examples, some regions in the network are more susceptible to cyber-attacks and they can contain more misbehaving nodes compared to other regions. In such examples, the process 200 can know that some vehicles or nodes passing through the susceptible region may misbehave (e.g., due to signal disturbances, cyber-attacks, obstacles, etc.). Then, the process 200 can determine or identify those vehicles or nodes, which pass by or through or next to the predetermined susceptible region as possible misbehaving vehicles or nodes. In some examples, the determination or identification of the possible misbehaving vehicle or nodes can be performed in a designing phase of the multiagent system. In other examples, In some examples, the determination or identification of the misbehaving vehicle or nodes can be performed at any other phases (e.g., the runtime phase). In other examples, the process 200 can identify or determine the multiple possible misbehaving nodes based on one or more measured exogenous disturbances affected to the plurality of misbehaving nodes. In further examples, the process 200 can determine or identify possible misbehaving vehicles or nodes in any other suitable techniques.

At step 220, the process 200 can determine a directed sub-network (e.g., a directed sub-graph) of a subset of the multiple nodes based on a first directed communication path of a possible misbehaving vehicle or node of the multiple possible misbehaving nodes to a first vehicle or node of the multiple vehicles or nodes and a second directed communication path of a driver node of the multiple nodes to the first vehicle or nodes. In some examples, the multiple vehicle or nodes can be represented as a directed network (e.g., a directed graph). In some examples, the directed sub-network can represent communication directions between vehicles or nodes in the subset of the multiple nodes or vehicles. In some examples, to determine the directed sub-network or sub-graph of subset of the multiple vehicles or nodes, the process 200 can determine the first directed communication path between the first node to the possible misbehaving node of the multiple possible misbehaving nodes and include multiple first communication path nodes on the first directed communication path in the directed graph. In some examples, the first communication path nodes on the first directed communication path can include at least one of: a second possible misbehaving node of the multiple possible misbehaving nodes or a floating node of the plurality of nodes. In some examples, the first vehicle or node can be a critical vehicle or node in the networked multiagent system.

In further examples, to determine the directed sub-network of the subset of the multiple nodes, the process 200 can determine the second directed communication path between the first node to the driver node of the multiple nodes and include multiple second communication path nodes on the second directed communication path in the directed graph. In some examples, the second communication path nodes on the second directed communication path can include at least one of: a second misbehaving node of the plurality of nodes or a floating node of the plurality of nodes. In some examples, the first node can be a critical vehicle or node in the networked multiagent system.

For example, the directed sub-network of the subset of multiple nodes can be determined based on the following conditions: i) driver vehicle/node(s) having at least one directed path to the first vehicle/node (e.g., the critical vehicle/node), where no other driver vehicle/node(s) on such directed path(s), ii) misbehaving vehicle/node(s) having at least one directed path to the first node, where no driver vehicle/node(s) on such directed path(s), iii) floating or misbehaving vehicle/node(s) on the directed path(s) from driver vehicle/node(s) (respectively, misbehaving vehicle/node(s)) satisfying i) (respectively, ii)) to the first vehicle/node, where no other driver vehicle/node(s) on such directed path(s), and/or iv) floating vehicle/node(s) on the directed path(s) between vehicle/nodes satisfying condition iii), where no driver vehicle/node(s) on such directed path(s). Thus, the directed sub-network can include vehicles or nodes, which only can affect the critical vehicle or node. By reducing the size of the directed network, the process 200 can effectively save computing resources and improve efficiency and computing speed by not processing other possible misbehaving vehicles outside of the directed sub-network.

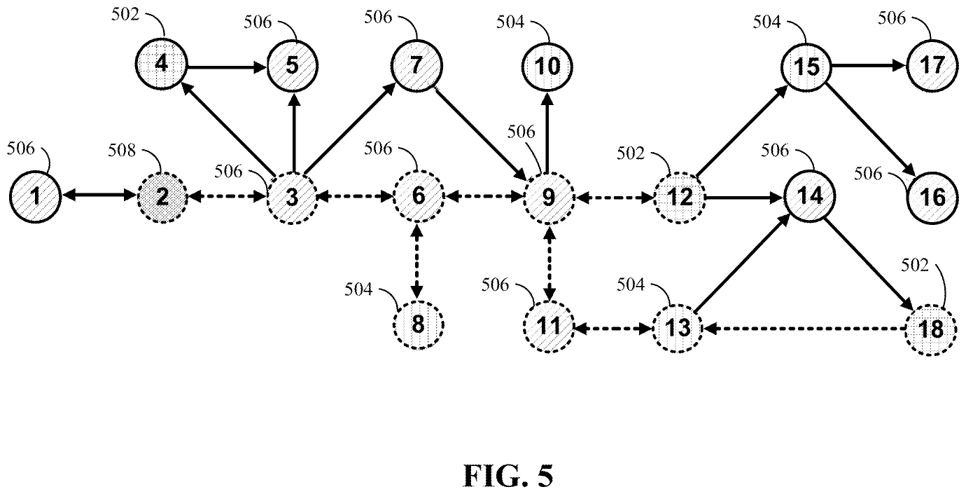

At step 230, the process 200 can implement a proportional-integral controller for suppressing an effect of the possible misbehaving node on the networked multiagent system. In some examples, the proportional-integral controller can produce a control signal based on a global command and an integrator state. For examples, the proportional-integral controller for a driver node or a misbehaving node included in the directed graph can produce a control input (u(t)) defined by: u(t)=−γ₁(γ(t)−1ₘc(t))−γ₂z(t) and the integrator state (z(t)) defined by: ż(t)=y(t)−1ₘc(t), z(0)=z₀, t≥0. Here, y(t) denotes the output of driver vehicle(s)/node(s) and [symbol] denotes a column vector composed of all ones. The integrator state denotes the difference between the output of driver nodes and the desired command. In some examples, the integrator state can be used to suppress undesired effects of misbehaving nodes. In some examples, the proportional-integral controller is implemented to the misbehaving node. In further examples, the proportional-integral controller is implemented to a neighbor node to the misbehaving node. For example, if the controller is not able to be implemented to the misbehaving node, the process can implement the controller to a neighbor node, which is a next node to the misbehaving node in the directed graph. Thus, the process 200 can suppress the negative effects of misbehaving nodes on the neighbor node. In some examples, the process 200 can implement the proportional-integral controller to a vehicle or node to suppress effects of multiple possible misbehaving vehicles or nodes. For example, referring to FIG. 5, when vehicles 8 (504), 11 (506), and 13 (504) are supposed to pass through a susceptible region, the process can determine that vehicles 8 (504), 11 (506), and 13 (504) are possible misbehaving vehicles. Although the vehicles 8 (504), 11 (506), and 13 (504) are in the sub-network, the process 200 can effectively implement the proportional-integral controller to the vehicle 6 in the sub-network, which can prevent all possible misbehaving effects of any of the vehicles 8 (504), 11 (506), and 13 (504). In such examples, the process 200 can further include turning a vehicle or node (e.g., vehicle 6) where multiple paths from multiple corresponding possible misbehaving vehicles (e.g., vehicles 8 (504), 11 (506), and 13 (504)) or nodes to the critical node 508 to a driver vehicle or node or implement the proportional-integral controller to the vehicle (e.g., vehicle 6).

In further examples, the process 200 can determine a steady-state indication of each node of the subset of the multiple nodes. In some examples, to determine the steady-state indication of each node of the subset of the multiple nodes, the process 200 can use the equation, x*ᵣ=1ₙ_{ᵣ}c̅+(Iₙ_{ᵣ}−Jᵣ⁻¹Bᵣ(Bᵣ^{T}Jᵣ⁻¹Bᵣ)⁻¹Bᵣ^{T})Jᵣ⁻¹Dᵣw̅ᵣ, which is described in detail below. In further examples, the process 200 can determine a steady-state indication of each node of the multiple nodes (e.g., using the equation, x*=1ₙc̅+(Iₙ−J⁻¹B(B^{T}J⁻¹B)⁻¹B^{T})J⁻¹Dw̅). In the examples, the process 200 may have obtained a Laplacian matrix of the overall network. In some examples, the steady-state values of the nodes can be utilized to understand the effects of misbehaving nodes to the network. In addition, the efficacy of the control approach can be demonstrated by showing the steady-state values of nodes because if the steady-state value of nodes can be the same as the desired command, then they are suppressing the adverse effects of misbehaving nodes and behaving as desired. Otherwise, the control approach and driver node selections in some examples might not work for nodes, which have steady-state values differing from the desired command.

In the foregoing specification, a multiagent network is described, and the multiagent network includes n scalar nodes exchanging their relative state information within each other according to a fixed, connected, and directed graph topology [symbol] . This network has three types of nodes: namely, misbehaving nodes, driver nodes, and floating nodes. Specifically, misbehaving nodes are subject to exogenous disturbances, driver nodes receive feedback control signals, and floating nodes are subject to neither exogeneous disturbances nor feedback control signals. Here, the focus is on suppressing the effects of misbehaving nodes on the multiagent network.

To address this problem, proportional-integral feedback controllers are disclosed to be executed by the driver nodes where the number of driver nodes can be less than the total number of all nodes. In particular, the structure of the proposed feedback controllers allows the stability of the overall multiagent network in the sense of input-to-state stability to be shown, where the steady-state values of all nodes are also provided. Next, considering large-scale, complex multiagent networks, the fact that it may be a challenge to obtain the Laplacian matrix of the overall multiagent network is acknowledged. To this end, a graph-theoretical approach to obtain steady-state value of critical nodes over sub-Laplacian matrices in the theoretical approach is provided herein. The graph-theoretical approach further paves the way in understanding how the driver nodes need to be selected for suppressing the effect of misbehaving nodes on the neighborhood of the critical nodes. Mathematically speaking, the dynamics of the overall multiagent network can be compactly given by:

\dot{x}(t)=− [symbol] x(t)+Bu(t)+Dw(t), x(0)=x₀, t≥0 (1)

y(t)=B^{T}x(t) (2)

where x(t)=[x₁(t), . . . , xₙ(t)]^{T}∈ [symbol] is the state of nodes, u(t)=[u₁(t), . . . , uₘ(t)]^{T}∈ [symbol] is the aggregated control inputs applied to the driver nodes, and w(t)=[w₁(t), . . . , w₁(t)]^{T}∈ [symbol] is the aggregated bounded exogenous disturbances with bounded time derivatives that affect misbehaving node. Here, B=[b₁, . . . , bₘ)]∈ [symbol] and D=[d₁, . . . , d₁)]∈ [symbol] respectively represent the driver and misbehaving nodes in [symbol] , where bᵢ∈ [symbol] is a unit vector with its j^{th} element being 1 to receive a control input uᵢ(t) (i.e., j^{th} node is a driver node in [symbol] ) and dᵢ∈ [symbol] is a unit vector with its k^{th} element being 1 that is affected by an exogeneous disturbance wᵢ(t) (i.e., k^{th} node is a misbehaving node in [symbol] ).

Now, the proportional-integral controller for driver nodes is disclosed, given by

u(t)=−γ₁(y(t)−1ₘc(t))−γ₂z(t) (3)

ż(t)=y(t)−1ₘc(t), z(0)=z₀, t≥0 (4)

where γ₁, γ₂∈R_{>0} denote the controller parameters, z(t)∈ [symbol] denotes the integrator states, and c(t)∈ [symbol] denotes the desired command.

The proposed controller (3) and (4) for the multiagent network (1) and (2) solve the problem described above when the graph [symbol] contains a spanning tree with the root nodes being the driver nodes (Condition 1). For the control of multiagent networks over directed graph topologies, this assumption is standard, and it implies that the union of the driver nodes has a directed path to every other node in the graph [symbol] .

The multiagent network (1) and (2) subject to the proposed controller (3) and (4) satisfies the dynamics given by

\dot{x}(t)=−Jx(t)−γ₂Bz(t)+γ₁B1ₘc(t)+Dw(t), x(0)=x₀, t≥0 (5)

ż(t)=B^{T}x(t)−1ₘc(t), z(0)=z₀, t≥0 (6)

where J [symbol] [symbol] +γ₁BB^{T}. To show the stability of the closed-loop multiagent network given by (5) and (6), first, the following definition of the Z-matrix and the following lemma is needed.

Let F=[fᵢⱼ]∈ [symbol] be a Z-matrix if fᵢⱼ≤0 for all i,j=1, . . . , n such that i≠j. The following two conditions are then equivalent: i) The eigenvalues of F have positive real parts and ii) there exists a positive diagonal matrix S such that ES+SE^{T} is positive-definite (Lemma 1). Based on this, the definition of matrix J can be considered. Then, J^{T}S+SJ is positive definite (Lemma 2).

It can be observed that γ₁BB^{T} is a square matrix full of zeros except some positive elements on its diagonal, and therefore, J is a Z-matrix by definition. In addition, J matrix is nonsingular and all of its eigenvalues are located in the open right-half plane. It can also be observed that J^{T} is also a Z-matrix and has the same eigenvalues as matrix J. Hence, from ii) Lemma 1, there exists a positive diagonal matrix S such that J^{T}S+SJ is positive definite.

Now, define η(t) [symbol] [x^{T}(t), z^{T}(t)]^{T}. Using (5) and (6), one can write

\dot{η}(t)=A_{g}η(t)+B_{g}u*(t), η(0)=η₀, t≥0 (7)

where

$${A}_{g} = [ \begin{matrix}- J & - {γ}_{2} B \\ {B}^{T} & 0\end{matrix} ] , {B}_{g} = [ \begin{matrix}{γ}_{1} B {1}_{m} & D \\ {1}_{m} & 0\end{matrix} ] ,$$

and u*(t)=[c(t), w^{T}(t)]^{T}. In what follows, it can be considered that u*(t) is composed of bounded functions having bounded derivatives. If Condition 1 holds, the closed-loop multiagent network (7) is then input-to-state stable (Theorem 1).

It can be observed that u*(t) is a bounded function of time, since c(t) and w(t) are bounded functions of time by their definitions. To provide input-to-state stability of the closed-loop multiagent network (7), it is then sufficient to show that A_{g} is asymptotically stable, meaning that A_{g} is Hurwitz; hence, let u*(t)=0 in (7) to show A_{g} being Hurwitz.

Next, without loss of generality, enumerate nodes in the network in such a way that the first m nodes represent the driver nodes. From Lemma 2, there exists a positive diagonal matrix S (i.e., S=diag(s₁, . . . , sₙ) and s₁>0 for all i=1, . . . , n) such that J^{T}S+SJ is positive definite. Let S̅ be another positive diagonal matrix such that S̅=diag(s₁, . . . , sₙ), where m≤n by definition. Consider now the Lyapunov function V(x,z)=x^{T}Sₓ+γ₂z^{T}S̅z, where V(0,0)=0, V(x,z)>0 for all (x,z)≠(0,0), and V(x,z) is radially bounded. The time derivative of this function satisfies \dot{V}(⋅)=−x^{T}(t)(J^{T}S+SJ)x(t)−2γ₂z^{T}(t)B^{T}Sx(t)+2γ₂z^{T}(t)S̅B^{T}x(t)=−x^{T}(t)(J^{T}S+SJ)x(t)≤0.

Finally, define a set S [symbol] {η(t)∈R^{n+m}:x(t)=0}. If \dot{V}(η(t))=0, then x(t) must be zero since J^{T}S+SJ is positive definite. Therefore, S={η(t)∈ [symbol] :x(t)=0}. Suppose that η(t) is a solution that belongs identically to S. Since x(t)≡0, then \dot{x}(t)≡0. It can be deduced from (5) that γ₂Bz(t)≡0, or equivalently, Bz(t)≡0 since γ₂ is a positive real number. From the structure of B, it is clear that B^{T}B is nonsingular, and therefore, Bz(t)≡0 implies z(t)≡0. Hence the trivial solution η(t)≡0 is the only solution, which identically stay in S. As a consequence, the origin is globally asymptotically stable, and therefore, A_{g} is Hurwitz.

Theorem 1 not only shows input-to-state stability of the closed-loop multiagent network (7) but also implies η(t) to asymptotically approach (respectively, approximately approach) to its equilibrium point when u*(t) is constant (respectively, time-varying).

Let Condition 1 hold and B^{T}J⁻¹B be non-singular. Then, J⁻¹B(B^{T}J⁻¹B)⁻¹1ₘ=1ₙ (Lemma 3). Consider (B^{T}J⁻¹B)⁻¹1ₘ=1ₙ. Define θ=γ₁1ₘ. One can show that (B^{T}J⁻¹B)⁻¹1ₘ=θ, or equivalently, (B^{T}J⁻¹B)θ=1ₘ holds, which is a linear equation. Since B^{T}J⁻¹B is nonsingular, then θ=γ₁1ₘ is the unique solution of the linear equation. Now, one can also write J⁻¹B(B^{T}J⁻¹B)⁻¹1ₘ as γ₁J⁻¹B1ₘ. Define s [symbol] 1ₙ. One can show that γ₁J⁻¹B1ₘ=s, or equivalently, γ₁B1ₘ=Js holds, which is a linear equation. Since J is nonsingular from Condition 1, then s [symbol] 1ₙ is the unique solution of the foregoing linear equation.

Let Condition 1 hold. Consider the closed-loop system given by (7) and let u*(t) be a constant vector denoted by ū*(t)=[c̅,w̅^{T}]^{T}. For all η₀∈ [symbol] ,

$${lim}_{t \to ∞} x ( t ) = {x}^{*} and {lim}_{t \to ∞} y ( t ) = {y}^{*}$$

can be used, where

x*=1ₙc̅+(Iₙ−J⁻¹B(B^{T}J⁻¹B)⁻¹B^{T})J⁻¹Dw̅ (8)

y*=1ₘc̅ (9)

An assistant state can be defined as

ζ(t) [symbol] η(t)+A_{g}⁻¹B_{g}ū* (10)

where the time derivative of (10) along with (7) yields

\dot{ζ}(t)=A_{g}ζ(t), ζ(0)=ζ₀, t≥0 (11)

### Hence,

$${lim}_{t \to ∞} ζ ( t ) = 0$$

for all ζ₀∈ [symbol] , since A_{g} is Hurwitz by Theorem 1, or equivalently, η*=−A_{g}⁻¹B_{g}ū* using (10) with “−A_{g}⁻¹B_{g}ū*” being the equilibrium point of (7), where

$${η}^{*} {=}^{Δ} {lim}_{t \to ∞} η ( t ) .$$

Rearranging η*=−A_{g}⁻¹B_{g}ū* as 0=A_{g}η*B_{g}ū* and noting η*=[x*^{T},z*^{T}]^{T}, the following is obtained:

x*=J⁻¹(−γ₂Bz*+γ₁B1ₘc̅+Dw̅) (12)

B^{T}x*=1ₘc̅ (13)

where (13) directly yields (9). To show (8), multiply both sides of (12) from left by B^{T} and use (13) to arrive

$${z}^{*} = \frac{{γ}_{1}}{{γ}_{2}} {1}_{m} \overline{c} - \frac{1}{{γ}_{2}} {( {B}^{T} {J}^{- 1} B )}^{- 1} {1}_{m} \overline{c} + \frac{1}{{γ}_{2}} {( {B}^{T} {J}^{- 1} B )}^{- 1} {B}^{T} {J}^{- 1} D \overline{w} .$$

Inserting this equation into (12) now yields

x*=J⁻¹B(B^{T}J⁻¹B)⁻¹1ₘc̅−J⁻¹B·(B^{T}J⁻¹B)⁻¹B^{T}J⁻¹Dw̅+J⁻¹Dw̅ (14)

Hence, (8) follows from (14) using Lemma 3.

The expression (8) can be used to understand the steady-state values of all nodes in the multiagent network. Specifically, while w̅ in (8) is unknown, one can choose a set of values for its entries to see how each node in the multiagent network gets affects. From the expression (9), in addition, one can directly see that the steady-state values of all driver nodes equal to the desired command, where this knowledge plays a key role in performing the local steady-state analysis presented herein.

The expression (8) is established for any number of driver and misbehaving nodes in the multiagent network. For the special case of a single driver node and a single misbehaving node, its simplified version is yet possible. In this case, the dynamics of the multiagent network becomes

x*(t)=− [symbol] x(t)+bu(t)+dw(t), x(0)=x₀, t≥0 (15)

y(t)=b^{T}x(t) (16)

where b∈ [symbol] and d∈ [symbol] are unit vectors for respectively choosing the driver node and misbehaving node in the multiagent network. Before presenting the steady-state values of all nodes for the special case of a single driver node and a single misbehaving node, introduced in the next lemma. Note that for the special case (i.e., single driver node and single misbehaving node), the J matrix is defined as J [symbol] [symbol] +γ₁bb^{T}.

Let Condition 1 hold. Then J⁻¹b=γ₁⁻¹1ₙ. Define r [symbol] γ₁⁻¹1ₙ. One can write J⁻¹b=γ₁⁻¹1ₙ as Jr=b. It can now be easily shown that r=γ₁⁻¹1ₙ satisfies Jr=b. Since J is nonsingular, r=γ₁⁻¹1ₙ is the unique solution of the foregoing linear equation (Lemma 4).

Let Condition 1 hold. Consider the closed-loop system given by (7) and let u*(t) be a constant vector denoted by u*(t)=ū* (Corollary 1). For the case of a singular driver node and a single misbehaving node, (8) becomes

x*(t)=1ₙc̅+(Iₙ−1ₙb^{T})J⁻¹dw̅ (17)

If, in addition, b=d, then (17) becomes x*=1ₙc̅. From Theorem 2, (12) and (13) become

x*=J⁻¹(−γ₂bz*+γ₁bc̅+dw̅) (18)

b^{T}x*=c̅ (19)

for the case of a single driver node and a single misbehaving node. Next, multiplying both sides of (18) from left by b^{T}, and using (19) and Lemma 3, one can obtain z*=γ₁γ₂⁻¹b^{T}J⁻¹dw̅. Inserting z* into (18) and using Lemma 3, (17) follows. Finally, when b=d, x*=1ₙc̅ from (17) by using Lemma 4. The proof is now complete.

Revisiting Theorem 2, the following remark provides a discussion for the case when u*(t) is not constant. In Theorem 2 and Corollary 1, the steady-state values of nodes in the multiagent network are established when u*(t) is constant (i.e., u*(t)≡ū*). Now, consider that u*(t) is time-varying. When ū* is replaced in (10) with u*(t), one can obtain the time-derivative of the assistant state (1) as

\dot{ζ}(t)=A_{g}ζ(t)+A_{g}⁻¹B_{g}\dot{u}*(t), ζ(0)=ζ₀, t≥0 (20)

Since A_{g} is Hurwitz, (20) is input-to-state stable with regard to \dot{u}*(t) being as input. Observe that when the time rate of change in \dot{u}*(t) is small, the closed-loop system trajectories of (7) stay close to its equilibrium point, which is given by (8) and (9) for the multiple driver nodes and the multiple misbehaving nodes case, and (17) for a single driver node and a single misbehaving node case. Finally, if

$${lim}_{t \to ∞} {\dot{u}}^{*} ( t )$$

then (8) and (9) of Theorem 2, and (17) of Corollary 1 still hold.

While the previous paragraphs investigate how to find the steady-state of nodes in the multiagent network, it uses the knowledge of the Laplacian matrix in (8) of Theorem 2 for the multiple driver nodes and multiple misbehaving nodes case and in (17) of Corollary 1 for the single driver node and single misbehaving node case. Acknowledging the face that it may be a challenge to obtain the complete Laplacian matrix of large-scale complex multiagent networks, the following provides a graph-theoretical approach to find the steady-state values of the critical nodes with minimum number of nodes in the multiagent network over sub-Laplacian matrices. Specifically, nodes needed to be take into account for this calculation are characterized. Once these nodes are chosen, a low-dimensional version of (8) (or (17)) can then be used to obtain the steady-state values of the critical nodes. To this end, the following conditions are made.

Let v_{c} denote a critical node in the multiagent network over a fixed, connected and directed graph [symbol] . There exists a fixed, connected, and directed subgraph [symbol] ᵣ containing nᵣ<n nodes that satisfy any conditions: i) driver node(s) having at least one directed path to v_{c}, where no other driver node(s) on such directed path(s), ii) misbehaving node(s) having at least one directed path to v_{c}, where no driver node(s) on such directed path(s), iii) floating or misbehaving node(s) on the directed path(s) from driver node(s) (respectively, misbehaving node(s)) satisfying i) (respectively, ii)) to v_{c}, where no other driver node(s) on such directed path(s), and iv) floating node(s) on the directed path(s) between nodes satisfying condition iii), where no driver node(s) on such directed path(s) (Condition 2).

Let xᵣ* denote the steady-state values of nodes contained in [symbol] ᵣ, including the steady-state value of v_{c}. Without loss of generality, the nodes are enumerated in [symbol] starting first with the nodes belonging to [symbol] ᵣ. One can then partition [symbol] as

$$ℒ = [ \begin{matrix}{ℒ}_{1} & {ℒ}_{2} \\ {ℒ}_{3} & {ℒ}_{4}\end{matrix} ] ,$$

where [symbol] ₁∈ [symbol] denotes a portion of corresponding to nodes in [symbol] . Now [symbol] ᵣ [symbol] [symbol] ₁+diag(Σⱼ₌ₙ_{ᵣ}₊₁^{j=n}m₁ⱼ, . . . , Σⱼ₌ₙ_{ᵣ}₊₁^{j=n}mₙ_{ᵣ}ⱼ) is defined, where mᵢⱼ denotes elements in [symbol] ₂. Next, Bᵣ=[bᵣ₁, . . . , bᵣₘ]∈ [symbol] , Dᵣ=[dᵣ₁, . . . , dᵣ₁]∈ [symbol] is defined, where bᵣᵢ∈ [symbol] is a unit vector with its j^{th} element being 1 (i.e., j^{th} node is a driver node in [symbol] ᵣ) and dᵣⱼ∈ [symbol] is a unit vector with its k^{th} element being 1 (i.e. k^{th} node is a misbehaving node in [symbol] ᵣ). Furthermore, let w̅ᵣₗ∈ [symbol] denote the aggregated exogenous disturbances, in which the misbehaving nodes in [symbol] ᵣ are subject to. For the single driver node and the single misbehaving node case, in addition, bᵣ and dᵣ respectively denote unit vectors for selecting a single driver node and single misbehaving node in [symbol] ᵣ, where w̅ᵣ∈ [symbol] denotes the exogenous disturbance the single misbehaving node is subject to. Finally, Jᵣ is defined for the case of multiple driver nodes and multiple misbehaving nodes as Jᵣ [symbol] [symbol] ᵣ+γ₁BᵣBᵣ^{T} and the case of single driver node and single misbehaving node as Jᵣ [symbol] [symbol] ᵣ+γ₁bᵣbᵣ^{T}, respectively.

Consider the conditions in Theorem 2. In addition, let Condition 2 hold.

x*ᵣ=1ₙ_{ᵣ}c̅+(Iₙ_{ᵣ}−Jᵣ⁻¹Bᵣ(Bᵣ^{T}Jᵣ⁻¹Bᵣ)⁻¹Bᵣ^{T})Jᵣ⁻¹Dᵣw̅ᵣ (21)

represents the case of multiple driver nodes and multiple misbehaving nodes, and

x*ᵣ=1ₙ_{ᵣ}c̅+(Iₙ_{ᵣ}−1ₙ_{ᵣ}bᵣ^{T})Jᵣ⁻¹dᵣw̅ᵣ (22)

for the special case of a single driver node and a single misbehaving node, where x*ᵣ denotes the steady-state values of nodes in [symbol] ᵣ including the steady-state value of v_{c} (Theorem 3).

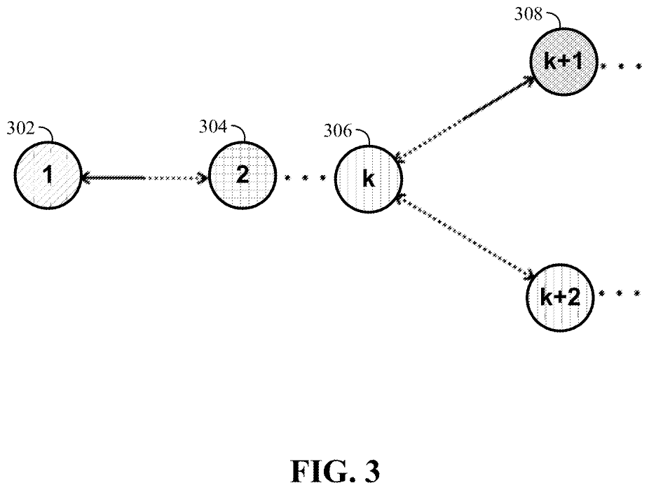

Now it is shown that one can find an expression for understanding the steady-state value of v_{c} with only nodes satisfying Condition 2. For the first part, assume on the contrary that some driver nodes and misbehaving nodes in [symbol] do not have any directed paths from themselves to v_{c}, where there are no other driver node(s) on such directed paths. To help visualize this, consider the case shown in FIG. 3 and let it denote a multiagent network over a fixed, connected, and directed graph [symbol] . In [symbol] , v₁ denotes the critical node 302 (i.e., v_{c}), v₂ denotes the floating node 304, vₖ and vₖ₊₂ denote the driver nodes 306, and vₖ₊₁ denotes the misbehaving node 308. In FIG. 3, solid and dotted line directions denote mandatory and optional information exchanging between nodes, respectively. Note that the reason behind mandatory information exchange between nodes comes from Condition 1. In addition, three dots may refer to other subgraphs in [symbol] . These sections may contain any type of nodes (i.e., floating, misbehaving, and driver nodes). Note that at least one driver node in vₖ must have a directed path to v_{c} due to Condition 1. Without loss of generality, consider that vₖ has a directed path to v_{c} without containing another driver node in FIG. 3. Furthermore, nodes vₖ₊₁ and vₖ₊₂ have no directed path (no other driver node(s) on such directed path(s)) to as assumed above. Now, nodes in can be grouped into two node sets Vₐ and V_{b}. Let nodes satisfying conditions i), ii), and iv) in Condition 2 belong to Vₐ and the remaining nodes belong to V_{b}. It is clear that the nodes v_{c} and v₂ satisfy iii) and node vₖ satisfy i). Hence, they belong to Vₐ. On the other hand, nodes vₖ₊₁ and vₖ₊₂ do not satisfy i) and ii), respectively, which means that they belong to V_{b}. Note that if there exist other nodes in unknown sections (i.e., three dots) satisfying any conditions i)-iv), they are also included in Vₐ.

Now, consider nodes vₖ₊₁ and vₖ₊₂ (driver and misbehaving nodes in V_{b}). They do not have a directed path without containing a driver node except themselves to nodes satisfying ii), iii), and iv) in Condition 2. Otherwise this contradicts the fact that nodes vₖ₊₁ and vₖ₊₂ do not satisfy i) and ii), respectively. Specifically, misbehaving nodes satisfying ii) have a directed path to v_{c} without containing a driver node. If nodes vₖ₊₁ and/or vₖ₊₂ have a directed path containing no driver node except themselves to these misbehaving nodes, then nodes vₖ₊₁ and/or vₖ₊₂ satisfy i) and ii), respectively. Similarly, vₖ₊₁ and vₖ₊₂ do not have a directed path containing no driver node except themselves to any nodes satisfying iii); because, these nodes are on the directed path between nodes satisfying i) and ii) (i.e., driver and misbehaving nodes in Vₐ) and v_{c}, which means that nodes satisfying iii) have a directed path without containing a driver node to v_{c}. Moreover, vₖ₊₁ and vₖ₊₂ do not have a directed path to nodes satisfying iv) since these nodes have a directed path without containing a driver node to nodes satisfying iii), which also have directed path to v_{c} without containing a driver node. Hence, nodes vₖ₊₁ and vₖ₊₂ have no directed path without containing driver nodes except themselves to nodes satisfying ii), iii), and iv) in Vₐ; but, they may have the directed path(s) to nodes satisfying i) (i.e., driver nodes in Vₐ). Thus, there is no incoming information from driver and/or misbehaving nodes (i.e., vₖ₊₁, vₖ₊₂) in V_{b} to nodes in Vₐ except the driver nodes (i.e., vₖ) in Vₐ.

Based on the definition given in Condition 2, [symbol] ᵣ is a fixed, connected and directed graph. Note that [symbol] ᵣ is composed of nodes in Vₐ. Since [symbol] has a spanning tree by Condition 1 and driver nodes in V_{b} do not have a directed path to nodes in Vₐ without containing driver nodes in Vₐ, then the subgraph [symbol] ᵣ composed of nodes in Vₐ has a spanning tree by driver nodes in Vₐ. In addition, observe that all driver nodes in follow the desired command irrespective of their neighboring nodes when [symbol] has a spanning tree, which can be obtained from the equation (9). Similarly [symbol] ᵣ has a spanning tree by driver nodes in Vₐ and these driver nodes follow the desired command when only [symbol] ᵣ was considered. This means that one can ignore the connections from all nodes in V_{b} to the driver nodes in Vₐ. Consider the rows in [symbol] ₁ corresponding to the driver nodes in Vₐ. Note that [symbol] ₂ denotes the links between nodes in V_{b} and nodes in Vₐ. For the purpose of network partitioning (i.e., obtaining sub-Laplacian matrix [symbol] ᵣ), the sum of nonzero values in [symbol] ₂ corresponding to each driver nodes in Vₐ is reducing from the degree value of each driver node in [symbol] ₁.

Consider the case shown in FIG. 2. Shown are floating nodes (in V_{b}) that do not satisfy both iii) and iv) in Condition 2 with different connection types (see connection types a), b), and c) in FIG. 2) that do not affect the steady-state value of nodes in Vₐ. Note that the misbehaving nodes not satisfying iii) in the proof are not considered; because, if a misbehaving node(s) does not satisfy iii), then it does not have a directed path(s) to v_{c} without containing a driver node, and therefore, this directly implies that the misbehaving node does not satisfy ii) either. As a consequence, the misbehaving node not satisfying iii) are separated from nodes in Vₐ as previously discussed. Now, assume on the contrary that some floating nodes in [symbol] do does not satisfy both ii) and iv) in Condition 2.

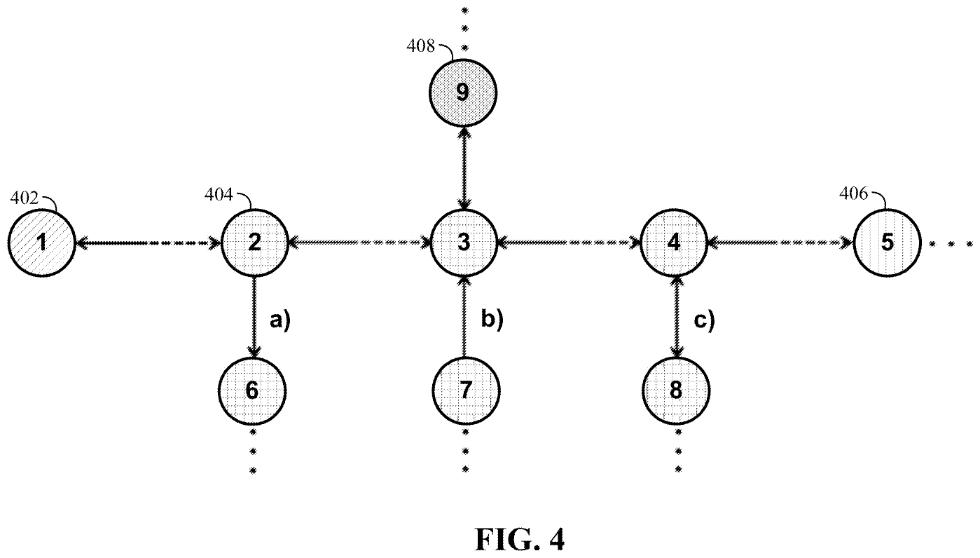

Focusing on the case shown in FIG. 4, v₁ denotes the critical node 402; v₅ denotes the driver node 406; v₂, v₃, v₄, v₆, v₇, and v₈ denote the floating nodes 404; and v₉ denotes the misbehaving node 408. Here, consider that node v₆, v₇, and v₈ are floating nodes, where do not satisfy both iii) and iv) in Condition 2. It is clear from the graph in FIG. 4 that nodes v₂, v₃, and v₄ satisfy iii). Similar to the previous case discussed, let nodes satisfying conditions i), ii), iii), and iv) belong to node set Vₐ and the remaining nodes belong to V_{b}.

First, consider node v₆ (connection type a)). Note that v₆ does not have a directed path from itself to v_{c} from its unknown section (without containing a driver node) shown in the figure by three dots. Otherwise, v₆ satisfies iii) and violated the condition since there exists at least a directed path from a driver node (i.e., v₅) in [symbol] to v₆ as a result of Condition 1. Note that node v₂ satisfying iii) have a directed path to v₆. Since node v₆ does not satisfy iv), then there must not exist a directed path(s) from v₆ to another node satisfying iii) (i.e., nodes v₃ and v₄) without having a driver node on the directed path(s). Hence, it is clear that node v₆ does not have a directed path to node v₇, v₈, and v₉. In addition, node v₆ does not have a directed path(s) to floating nodes satisfying iv); because these nodes have a directed path to nodes satisfying iii). Moreover, node v₆ does not have a directed path(s) to misbehaving nodes satisfying ii) since they have a directed path to v_{c}, which also satisfies iii). To summarize, one can conclude that node v₆ does not have a directed path to nodes satisfying ii), iii), and iv). Lastly, v₆ may have a directed path(s) from its unknown section to driver nodes satisfying i) (i.e., v₅). As previously discussed, there is no effect of incoming information to driver nodes. Hence, one can separate v₆ from nodes in Vₐ.

Second, consider node v₇ (connection type b)). Note that any driver nodes and/or misbehaving nodes in [symbol] do not have a directed path to v₇ over the unknown section of node v₇. Otherwise, v₇ satisfies iii) and violates the condition because node v₇ has a directed path from itself to v_{c} without containing a driver node. However, if there is not directed path to v₇ from any driver nodes in [symbol] through the unknown section of node v₇, then [symbol] has no spanning tree, which contradicts Condition 1. To summarize, if a floating node(s) (in V_{b}) has only a connection((s) type b) to nodes in Vₐ as shown in FIG. 4, the either there must exist a driver node(s) in [symbol] having a directed path to node v₇ from the unknown section of v₇ and node v₇ satisfy iii) or [symbol] does not have a spanning tree.

Third, consider node v₈ (connection type c)). Note that v₈ does not have a directed path(s) to v_{c} from its unknown section (without containing a driver node). Otherwise, it satisfies iii) and contradicts the condition since there exists at least a directed path from a driver node (i.e., v₅) to v₈ by Condition 1. Note that there are no driver node(s) and/or misbehaving node(s) having a directed path to v₈ from the unknown section of v₈. Otherwise v₈ satisfies iii) and contradicts the condition as well. In addition, node v₄ satisfying iii) have a directed path to v₈. Since node v₈ does not satisfy iv), then v₈ does not have a directed path(s) from its unknown section to nodes satisfy in iv), iii), and ii). To summarize, node v₈ does not have a directed path(s) from its unknown section to any nodes satisfying ii), iii), and iv) in Vₐ (i.e., v₁, v₂, v₃, v₄, and v₉) except nodes satisfying i) (i.e., driver nodes in Vₐ). Observe that this directed path(s) does not affect the steady-state value of these driver nodes. Next, the floating nodes (with connection type c)) is demonstrated as not satisfying both iii) and iv) and do not play a role in the steady-state value of nodes (i.e., v₄) in Vₐ. This helps to separate nodes in Vₐ from these nodes (i.e., v₈) to obtain the steady-state value of v_{c} with minimum number of nodes. Recall that A_{g} is Hurwitz when Condition 1 holds. When u*(t) is constant, nodes in [symbol] reach their steady-state value. From the previous discussion, it is clear that neither driver nodes nor misbehaving nodes do not have a directed path to v₈ from the unknown section of v₈. If there are nodes in the unknown section of v₈ having a directed path(s) to v₈, then they must be floating nodes. In addition, v₈ must have a directed path(s) to these nodes in its unknown section because of Condition 1. Now, consider a subgraph [symbol] , which is composed of v₄, v₈, and all nodes from the unknown section of v₈ having a directed path to v₈. It is clear that [symbol] is a fixed connected, and undirected graph. If v₄ is considered as a virtual leader in [symbol] , then one can show that all nodes in [symbol] follow node v₄. This means that all nodes in approach the same steady-state values. Consider (7) together with the result

$${lim}_{t \to ∞} \dot{η} ( t ) = 0$$

given in Theorem 1. Then, one can write the row corresponding to node v₄ in (7) as

0=x*₈−x*₄+x*₅−x*₄+x*₃−x*₄ (23)

when time goes to infinity. Since the steady-state values of nodes v₄ and v₈ are the same, they cancel out each other. Hence, v₈ can be separated from nodes in Vₐ since it does not affect the steady-state value of nodes in Vₐ. Note that if there does not exist an (optional) edge from v₃ to v₃, then the term x*₃−x*₄ can be ignored given in (23), which does not change the result.

To summarize, if driver node(s) (respectively, misbehaving node(s)) does not satisfy i) (respectively, ii)), then they do not have a directed path(s) to nodes satisfying ii), iii), and iv) but they may have a directed path(s) to nodes satisfying i) (i.e., driver nodes in Vₐ). In addition, [symbol] ᵣ has a spanning tree by the driver nodes in Vₐ. (i.e., the subgraph [symbol] ᵣ). Next, if floating nodes (in V_{b}) do not satisfy both iii) and iv), they (connection type a)) either do not have a directed path(s) to nodes in Vₐ (i.e., the subgraph [symbol] ᵣ) except driver nodes (i.e., v₅) in Vₐ or they (connection type c)) have a directed path(s) to nodes in Vₐ without affecting the steady-state value of nodes in Vₐ. Note that is also explained that floating nodes (in V_{b}) not satisfying both iii) and iv) cannot have only a connection(s) type b) with nodes in Vₐ. For the purpose of the network partitioning, the sum of nonzero values in [symbol] ₂ corresponding to each node in Vₐ communication with floating nodes in V_{b} (connection type c)) is reduced from the degree value of each node in Vₐ. Hence, one can obtain the sub-Laplacian matrix [symbol] ᵣ as defined before in Theorem 3, which represents the graph topology of subgraph [symbol] ᵣ. As a consequence, (21) for the case of multiple driver nodes and multiple misbehaving nodes in [symbol] ᵣ or (22) for the special case of a single driver node and a single misbehaving nodes in [symbol] ᵣ can be used toward x*ᵣ in [symbol] ᵣ, where x*ᵣ also includes the steady-state value of v_{c}.

Consider the subgraph [symbol] ᵣ and recall from Theorem 3 that it has a spanning tree. If there is no misbehaving node(s) in [symbol] ᵣ, then Dᵣw̅ᵣₗ=0 (respectively, dᵣw̅ᵣ=0 for the single case) in (21) (respectively, in (22)). Hence, one can conclude that the states of all nodes (i.e., floating and driver nodes) including the state of the critical node v_{c} in [symbol] ᵣ asymptotically approach to the desired command (i.e., x*ᵣ=1ₙ_{ᵣ}c̅).

FIG. 5 illustrates the multiagent network over a fixed, connected, and directed graph [symbol] , which has a spanning tree (i.e., Condition 1 holds). The multiagent network can include driver nodes 502, misbehaving nodes 504, floating nodes 506, a critical node 508 over a fixed, connected, and directed graph [symbol] . The subgraph [symbol] ᵣ is denoted with dotted nodes and dotted edges. The initial conditions of nodes are selected from the interval [−2.2], where γ₁=3, γ₂=1, and c̅=1 was chosen for the driver nodes (i.e., nodes 4, 12, and 18) executing the proposed controller (3) and (4), and w̅₈=0.5, w̅₁₀=−0.7, w̅₁₃=1.2, and w̅₁₅=−1.5 for the misbehaving nodes (i.e., nodes 8, 10, 13, and 15). Using (8) given in Theorem 2, one can find the steady-state values of nodes in [symbol] as x*=[2.6, 2.6, 2.6, 1, 1.8, 2.6, 2.6, 3.1, 2.1, 1.4, 2.1, 1, 2.2, 1.6, −0.5, −0.5, −0.5, 1]^{T} Observe that (8) uses the knowledge of the Laplacian matrix of the overall network. To this end, if one is only interested in the steady-state value of the critical node (i.e., v₂) in [symbol] , then the graph-theoretical approach presented in Theorem 3 is useful. Specifically, driver node v₄ does not satisfy i) in Condition 2 since it does not have a directed path to v_{c}. In addition, misbehaving nodes v₁₀ and v₁₅ do not satisfy ii) and iii) in Condition 2. Furthermore, floating nodes v₁, v₅, v₁₄, v₁₆, and v₁₇ do not satisfy both iii) and iv). Thus, one can obtain the subgraph [symbol] ᵣ from [symbol] by removing nodes in [symbol] not satisfying conditions i)-iv) in Condition 2, where nodes v₂, v₃, v₆, v₇, v₈, v₉, v₁₁, v₁₂, v₁₃, and v₁₈ in [symbol] is now enumerated as v₁, v₂, . . . , v₉, and v₁₀ for the subgraph [symbol] ᵣ. The steady-state value of the critical node v_{c} and other nodes in [symbol] ᵣ can then be obtained as x*=[2.6, 2.6, 2.6, 2.6, 3.1, 2.1, 2.1, 1, 2.2, 1]^{T} using (21) given in Theorem 3. Clearly, the result is consistent with the steady-state value of nodes obtained by Theorem 2.

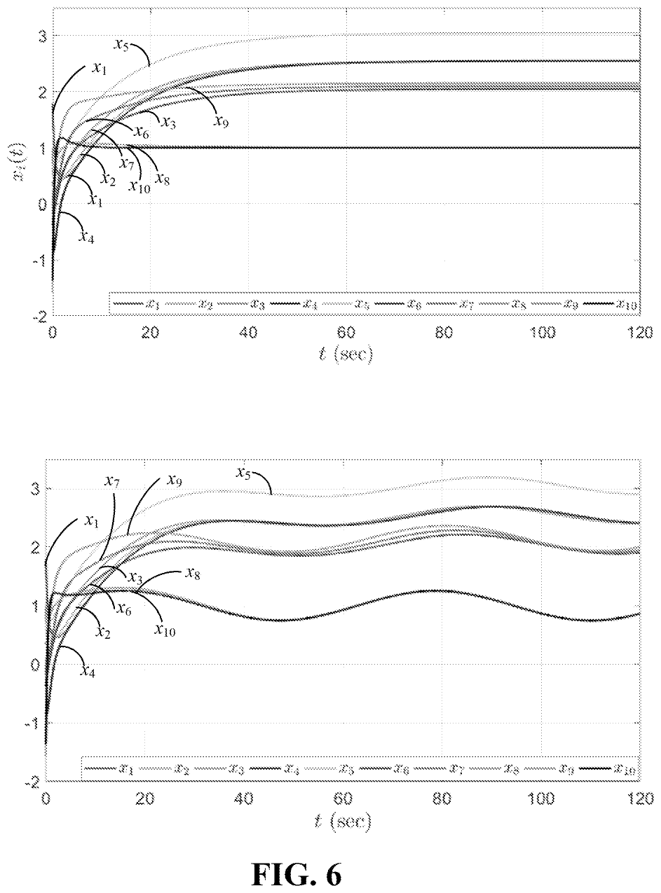

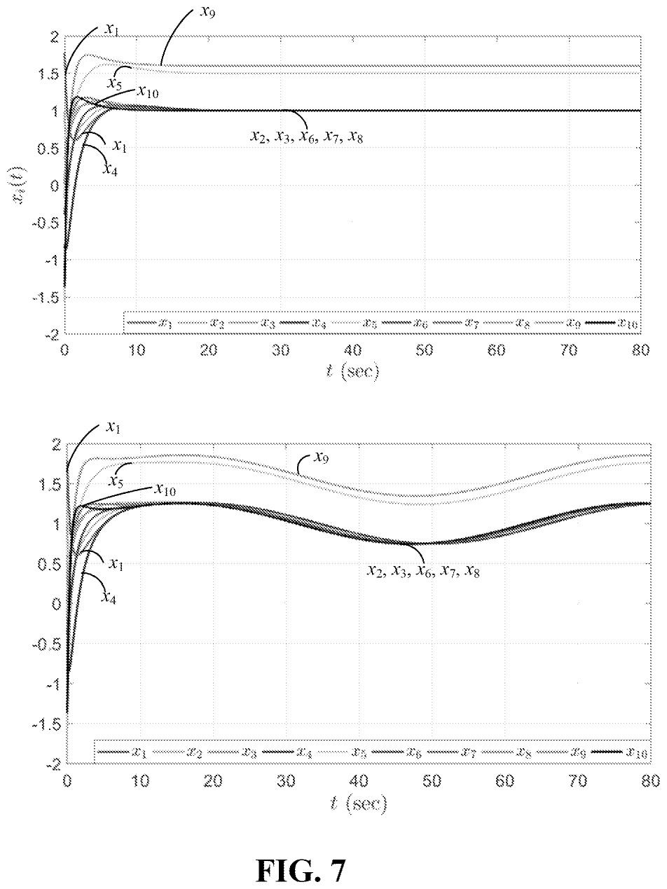

An additional example to demonstrate how to use the graph-theoretical approach in Theorem 3 in suppressing the negative effect of misbehaving nodes on the neighborhood of the critical node v_{c} (i.e., v₂) in [symbol] is now shown. In particular, observe that only misbehaving nodes v₈ and v₁₃ affect the neighborhood of the critical node. If it is desired for all nodes in [symbol] ᵣ to follow the desired command, then the proposed controller needs to be implemented to only nodes v₈ and v₁₃ in addition to other existing driver nodes in [symbol] . If this controller cannot be implemented directly to misbehaving nodes v₈ and v₁₃, then nodes v₆ and v₁₁ can also be chosen as the driver nodes, which paves the way for preventing misbehaving nodes v₈ and v₁₃ in [symbol] ᵣ from satisfying conditions ii) and iii) in Condition 2 anymore. Hence, negative affects of misbehaving nodes v₈ and v₁₃ on the neighborhood of v_{c} (i.e., [symbol] ᵣ) can be suppressed). To this end, the time response of nodes in [symbol] ᵣ is respectively shown in FIG. 6 and FIG. 7 when there are no additional driver nodes in [symbol] and nodes v₆ and v₁₁ in [symbol] (i.e., v₃ and v₇ in [symbol] ᵣ) are selected driver nodes in addition to v₄, v₁₂, and v₁₈ in [symbol] (to demonstrate Remark 3, the right sides of these figures show the time response when the command is time-varying according to c(t)=1+0.25 sin (0.1 t)). Here, x1 (in the graph) denotes v2 (in the FIG. 5), x2 (in the graph) denotes v3 (in the FIG. 5), x3 (in the graph) denotes v6 (in the FIG. 5), x4 (in the graph) denotes v7 (in the FIG. 5), x5 (in the graph) denotes v8 (in the FIG. 5), x6 (in the graph) denotes v9 (in the FIG. 5), x7 (in the graph) denotes v11 (in the FIG. 5), x8 (in the graph) denotes v12 (in the FIG. 5), x9 (in the graph) denotes v13 (in the FIG. 5) and x10 (in the graph) denotes v18 (in the FIG. 5).

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for networked multiagent system control, comprising:
identifying a plurality of possible misbehaving vehicles among a plurality of vehicles in the networked multiagent system, the plurality of vehicles being represented as a directed network;
determining a directed sub-network of a subset of the plurality of vehicles based on a first directed communication path of a possible misbehaving vehicle of the plurality of possible misbehaving vehicles to a first vehicle and a second directed communication path of a driver vehicle of the plurality of vehicles to the first vehicle, the directed sub-network representing communication directions between vehicles in the subset of plurality of vehicles; and
implementing a proportional-integral controller for suppressing an effect of the first possible misbehaving vehicle on the networked multiagent system.

2. The method of claim 1, wherein the plurality of possible misbehaving vehicles is identified based on a predetermined susceptible region.

3. The method of claim 1, wherein the determining of the directed sub-network of the subset of the plurality of vehicles comprises:
determining the first directed communication path between the first vehicle to the possible misbehaving vehicle; and
including a plurality of first communication path vehicles on the first directed communication path in the directed sub-network.

4. The method of claim 3, wherein the plurality of first communication path vehicles on the first directed communication path comprises at least one of: a second possible misbehaving vehicle of the plurality of possible misbehaving vehicles or a floating vehicle of the plurality of vehicles.

5. The method of claim 3, wherein the determining of the directed sub-network of subset of the plurality of vehicles further comprises:
determining the second directed communication path between the first vehicle to the driver vehicle of the plurality of vehicles; and
including a plurality of second communication path vehicles on the second directed communication path in the directed sub-network.

6. The method of claim 5, wherein the plurality of second communication path vehicles on the second directed communication path comprises at least one of: a second possible misbehaving vehicle of the plurality of vehicles or a floating vehicle of the plurality of vehicles.

7. The method of claim 1, wherein the first vehicle comprises a critical vehicle.

8. The method of claim 1, wherein the proportional-integral controller is configured to produce a control signal based on a global command and an integrator state.

9. The method of claim 1, wherein the proportional-integral controller is implemented to the possible misbehaving vehicle.

10. The method of claim 1, wherein the proportional-integral controller is implemented to a neighbor vehicle to the possible misbehaving vehicle.

11. The method of claim 1, further comprising:
determining a steady-state indication of each vehicle of the subset of the plurality of vehicles.

12. A server for networked multiagent system control, comprising:
a processor; and
a memory having stored thereon a set of instructions which, when executed by the processor, cause the processor to:
determine a plurality of possible misbehaving vehicles among a plurality of vehicles in the networked multiagent system;
determine a directed sub-network of a subset of the plurality of vehicles based on a first directed communication path of a possible misbehaving vehicle of the plurality of possible misbehaving vehicles to a first vehicle and a second directed communication path of a driver vehicle of the plurality of vehicles to the first vehicle, the directed sub-network representing communication directions between vehicles in the subset of plurality of vehicles; and
implement a proportional-integral controller for suppressing an effect of the possible misbehaving vehicle on the networked multiagent system.

13. The server of claim 12, wherein the plurality of possible misbehaving vehicles is determined based on a predetermined susceptible region.

14. The server of claim 12, wherein to determine the directed sub-network of the subset of the plurality of vehicles, the processor is configured to:
determine the first directed communication path between the first vehicle to the possible misbehaving vehicle; and
include a plurality of first communication path vehicles on the first directed communication path in the directed sub-network.

15. The server of claim 14, wherein to determine the directed sub-network of subset of the plurality of vehicles, the processor is further configured to:
determine the second directed communication path between the first vehicle to the driver vehicle of the plurality of vehicles; and
include a plurality of second communication path vehicles on the second directed communication path in the directed sub-network.

16. The server of claim 15, wherein the plurality of first communication path vehicles on the first directed communication path or the plurality of second communication path vehicles on the second directed communication path comprises at least one of: a second possible misbehaving vehicle of the plurality of possible misbehaving vehicles or a floating vehicle of the plurality of vehicles.

17. The server of claim 12, wherein the first vehicle comprises a critical vehicle.

18. The server of claim 12, wherein the proportional-integral controller is configured to produce a control signal based on a global command and an integrator state.

19. The server of claim 12, wherein the proportional-integral controller is implemented to the misbehaving vehicle.

20. The server of claim 12, wherein the proportional-integral controller is implemented to a neighbor vehicle to the misbehaving vehicle.
